(19) United States
(12) Patent Application Publication
(10) Pub. No.: US 2026/0106423 A1
(43) Pub. Date: Apr. 16, 2026

(54) RATCHET CRIMPING PLIER STRUCTURE

(71) Applicant: KAUW YEHI INDUSTRIAL CO., LTD., New Taipei City (TW)

(72) Inventor: Yu-Ting YEN, New Taipei City (TW)

(21) Appl. No.: 18/915,233

(22) Filed: Oct. 14, 2024

(51) Int. Cl. H01R 43/042

(52) U.S. Cl. CPC H01R 43/042

(57) ABSTRACT

A ratchet crimping plier structure is disclosed. A first plier handle set and a second plier handle set are pivotally connected to a first base and a second base. An edge-cutting set is disposed on the plier handle sets. A pivot set is disposed on the main body and includes a central shaft, a first and second torsion springs. One end of the first torsion spring abuts against the first plier handle set, and another end abuts against the second plier handle set. One end of the second torsion spring is fixed on the central shaft, and another end is fixed on the second base. The pair of plier handle sets opens and closes to perform a horizontal cut by the edge-cutting set. The second base performs a vertical cut by the clamp-cutting set.

### BACKGROUND OF THE DISCLOSURE

### Technical Field

The technical field relates to a hand tool, and particularly to a ratchet crimping plier structure.

### Description of Related Art

A ratchet crimping tool is a common hand tool used to remove the insulation layer from electrical wires or cables and expose the conductor inside the wire for electrical connections. Additionally, the ratchet crimping tool is equipped with a spring mechanism to make the pliers return to their initial position.

Furthermore, the spring of the ratchet crimping tool is usually located between two handles to perform an effective operation when the pliers open and close. However, since the spring needs to be precisely installed in a specific position between the handles, production and maintenance are complex. Additionally, the spring positioned between the handles is easily impacted or squeezed by foreign objects, which increases the risk of deformation or breakage of the spring, potentially causing the spring to be tripped or displaced, resulting in inconvenience of use. In this regard, how to extend the service life of tools and improve their safety is the research motivation of the applicant in this disclosure.

In view of the above drawbacks, the inventor proposes this disclosure based on his expert knowledge and elaborate researches in order to solve the problems of related art.

### SUMMARY OF THE DISCLOSURE

This disclosure provides a ratchet crimping plier structure to extend the service life and improve safety of use.

This disclosure is a ratchet crimping plier structure. A main body includes a first base and a second base. A clamping piece is disposed on one side of the first base. A clamp-cutting set is disposed on one side of the second base. A pair of plier handle sets includes a first plier handle set pivotally connected to the first base, and a second plier handle set pivotally connected to the second base. An edge-cutting set is disposed on the plier handle sets. A pivot set is disposed on the main body and includes a central shaft, a first and second torsion springs. One end of the first torsion spring abuts against the first plier handle set, and another end thereof abuts against the second plier handle set. One end of the second torsion spring is fixed on the central shaft, and another end thereof is fixed on the second base. The central shaft passes through the main body, the pair of plier handle sets, the first torsion spring and the second torsion spring to be fixed on the main body. The pair of plier handle sets opens and closes relative to each other through the first torsion spring to perform a horizontal cut by the edge-cutting set. The second base performs a vertical cut by the clamp-cutting set through the second torsion spring.

In comparison with the related art, the pivot set of the ratchet crimping plier structure in this disclosure includes a central shaft, a first torsion spring, and a second torsion spring located on two sides of the central shaft opposite to each other. One end of the first torsion spring abuts against the first plier handle set, and the other end abuts against the second plier handle set. One end of the second torsion spring is fixed on the central shaft, and the other end is fixed on the second base. The central shaft passes through the main body, the pair of pliers, the first torsion spring, and the second torsion spring to be fixed on the main body. Accordingly, the pair of plier handle sets opens and closes relative to each other through the first torsion spring to perform a horizontal cut by the edge-cutting set. Since the first and second torsion springs are arranged on the main body to prevent users from accidentally being touched, the risk of the first and second torsion springs being deformed or broken due to impact or squeeze by foreign objects, or even tripping or displacement, may be avoided. Additionally, the first and second torsion springs are arranged on the main body and are not exposed to the external environment. This may help avoid dust accumulation, which affects operation, and increases the convenience and practicality of use.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 and FIG. 2 depict perspective schematic views of the ratchet crimping plier structure from two sides according to this disclosure.

FIG. 3 and FIG. 4 depict perspective exploded schematic views of the ratchet crimping plier structure from two sides according to this disclosure.

FIG. 5 and FIG. 6 depict cross-sectional views of the ratchet crimping plier structure according to this disclosure.

FIG. 7 depicts another embodiment of the ratchet crimping plier structure according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

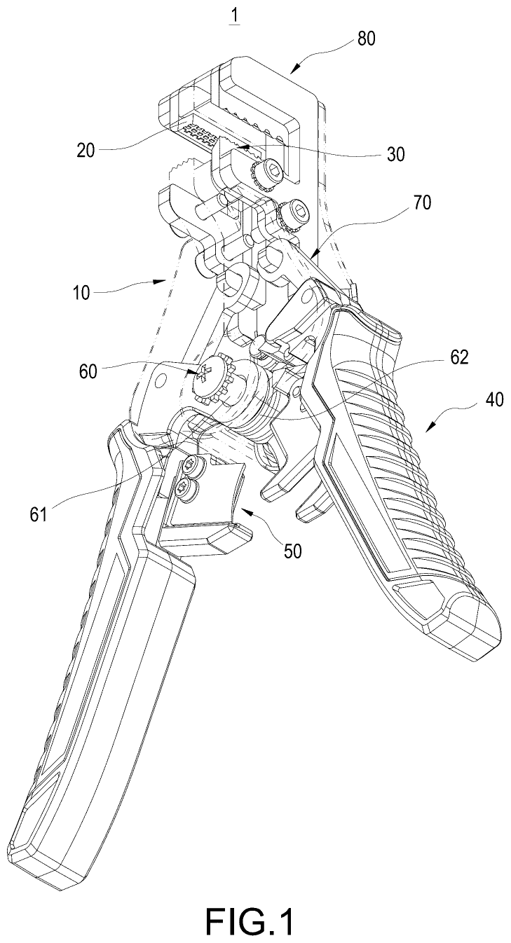

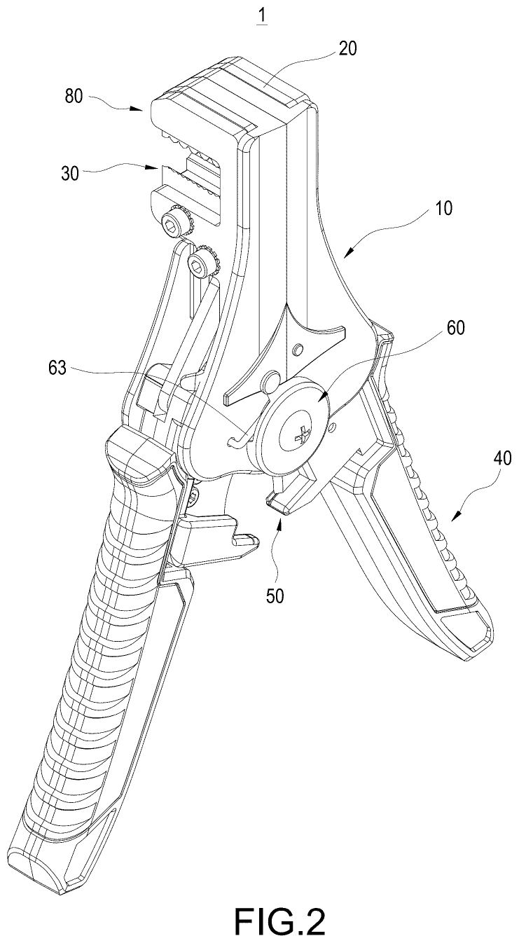

Please refer to FIG. 1 and FIG. 2, which depict perspective schematic views of the ratchet crimping plier structure from two sides according to this disclosure. The ratchet crimping plier structure 1 includes a main body 10, a clamping piece 20, a clamp-cutting set 30, a pair of plier handle sets 40, an edge-cutting set 50, and a pivot set 60. The clamping piece 20 and the clamp-cutting set 30 are combined on the upper side of the main body 10. The pair of plier handle sets 40 is pivotally connected to the bottom side of the main body 10, and the edge-cutting set 50 is correspondingly arranged on the pair of plier handle sets 40. Additionally, the pivot set 60 is disposed on the main body 10. The pivot set 60 includes a central shaft 61, a first torsion spring 62 and a second torsion spring 63 located on two sides of the central shaft 61 opposite to each other.

In this embodiment, the ratchet crimping plier structure 1 further includes a linkage set 70 and a panel set 80. The pair of plier handle sets 40 is connected to the linkage set 70 to drive the clamping piece 20 and the clamp-cutting set 30 to move. Additionally, the panel set 80 is disposed on two sides of the main body 10 correspondingly. The clamping piece 20 and the clamp-cutting set 30 are movable and separately located on the inner side of the panel set 80. More details of the ratchet crimping plier structure 1 are described as follows.

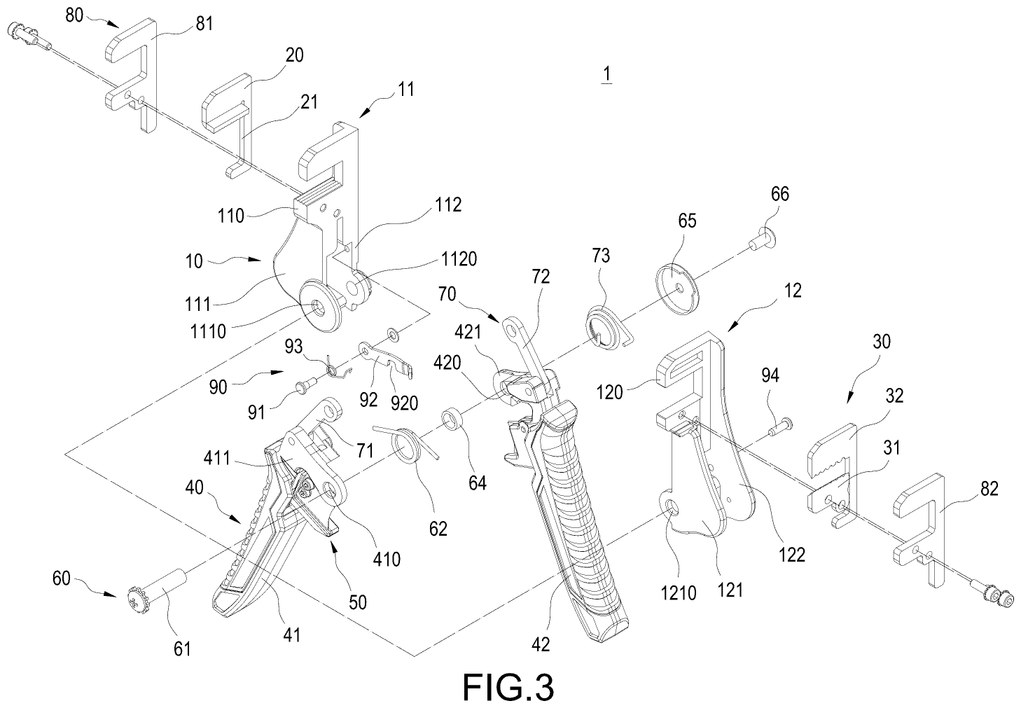

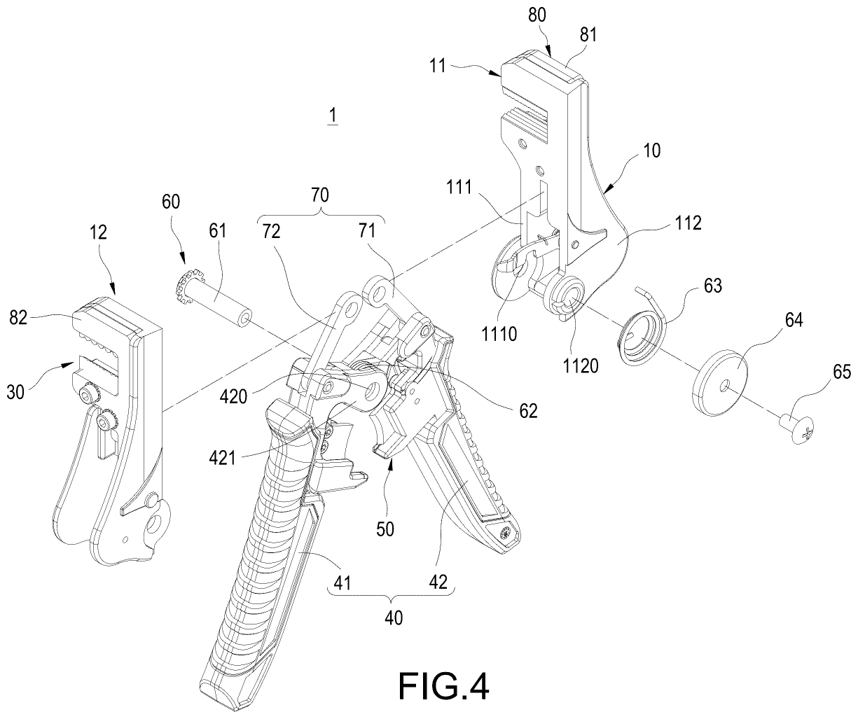

Please refer to FIG. 3 and FIG. 4, which are perspective exploded schematic views of the ratchet crimping plier structure from two sides according to this disclosure. The main body 10 includes a first base 11 and a second base 12 disposed correspondingly. The first base 11 includes a first jaw section 110, and a serrated pattern is disposed on the surface of the first jaw section 110. The second base 12 includes a second jaw section 120 disposed corresponding to the first jaw section 110.

In this embodiment, the first base 11 includes a first front plate 111 and a first rear plate 112 arranged oppositely. A first front hole 1110 is defined on the first front plate, and a first rear hole 1120 is defined on the first rear plate 112. Additionally, the first jaw section 110 straddles between the first front plate 111 and the first rear plate 112. Similarly, the second base 12 includes a second front plate 121 and a second rear plate 122 arranged oppositely. A second front hole 1210 is defined on the second front plate 121, and a second rear hole 1220 is defined on the second rear plate 122. The central shaft 61 sequentially passes through the first front hole 1110, the second front hole 1210, the second rear hole 1220, and the first rear hole 1120.

The clamping piece 20 is disposed on one side of the first base 11. The clamp-cutting set 30 is disposed on one side of the second base 12. An opening 21 is defined on the clamping piece 20 and is located correspondingly to the first jaw section 110, and a serrated pattern is disposed on the surface of the opening 21. The clamp-cutting set 30 includes a fixed blade 31 and a movable blade 32. The fixed blade 31 and the movable blade 32 are arranged on two sides of the second jaw section 120 opposite to each other.

The pair of plier handle sets 40 includes a first plier handle set 41 pivotally connected to the second base 12 and a second plier handle set 42 pivotally connected to the second base 12. Additionally, the edge-cutting set 50 is disposed on the pair of plier handle sets 40 correspondingly.

The pivot set 60 includes a central shaft 61, a first torsion spring 62, and a second torsion spring 63 located on two sides of the central shaft 61. One end of the first torsion spring 62 abuts against the first plier handle set 41, and the other end abuts against the second plier handle set 42. One end of the second torsion spring 63 is fixed on the central shaft 61, and the other end is fixed on the second base 12. Additionally, the central shaft 61 passes through the first base 11, the second base 12, the pair of plier handle sets 40, the first torsion spring 62, and the second torsion spring 63, and is fixed on the main body 10. Therefore, the pair of plier handle sets 40 opens and closes relative to each other through the first torsion spring 62 and performs a horizontal cut (in the left and right direction) by the edge-cutting set 50. Additionally, the second base 12 performs a vertical cut (in the up and down direction) by the clamp-cutting set 30 through the second torsion spring 63.

In this embodiment, the pivot set 60 further includes a sleeve 64. The sleeve 64 is adapted to sheath between the central shaft 61 and the first torsion spring 62 to prevent the first torsion spring 62 from contacting the central shaft 61 and to avoid causing damage to the central shaft 61 when the first torsion spring 62 rotates. Moreover, the pivot set 60 further includes a rear cover 65 and a fastener 66. The rear cover 65 covers the second torsion spring 63. The fastener 66 passes through the rear cover 65 and is combined with the central shaft 61.

It is worth noticing that the first plier handle set 41 includes a first arm 411, and a first perforation 410 is defined on the first arm 411. The second plier handle set 42 includes a second arm 421, and a second perforation 420 is defined on the second arm 421. The central shaft 61 passes through the first perforation 410 and the second perforation 420.

In this embodiment, the ratchet crimping plier structure 1 further includes a linkage set 70. The linkage set 70 includes a first rod 71 and a second rod 72. Two ends of the first rod 71 are pivotally and respectively connected to the first plier handle set 41 and the clamping piece 20, and two ends of the second rod 72 are pivotally and respectively connected to the second plier handle set 42 and the movable blade 32 of the clamp-cutting set 30.

Moreover, the ratchet crimping plier structure 1 further includes a panel set 80. The panel set 80 includes a first panel 81 and a second panel 82. The first panel 81 is fixed to the first base 11 and covers the clamping piece 20. The clamping piece 20 is driven by the first rod 71 to move between the first panel 81 and the first base 11. Additionally, the second panel 82 is fixed to the second base 12 and covers the clamp-cutting set 30. The movable blade 32 is driven by the second rod 72 to move between the second panel 82 and the second base 12.

In this embodiment, the ratchet crimping plier structure 1 further includes an elastic arm set 90 disposed on the main body 10. The elastic arm set 90 includes a fixed shaft 91, a buckle arm 92, a third torsion spring 93, and a buckle column 94. The fixed shaft 91 is fixed on the first base 11 and passes through the buckle arm 92 and the third torsion spring 93. The buckle arm 92 extends to the second base 12, and a locking groove 920 is defined on the buckle arm 92. One end of the third torsion spring 93 is positioned on the first base 11, and the other end elastically contacts the buckle arm 92. The buckle column 94 is located on the second base 12. Additionally, the locking groove 920 is engaged with the buckle column 94 when the pair of plier handle sets 40 is pressed and returns to its original position by the third torsion spring 93.

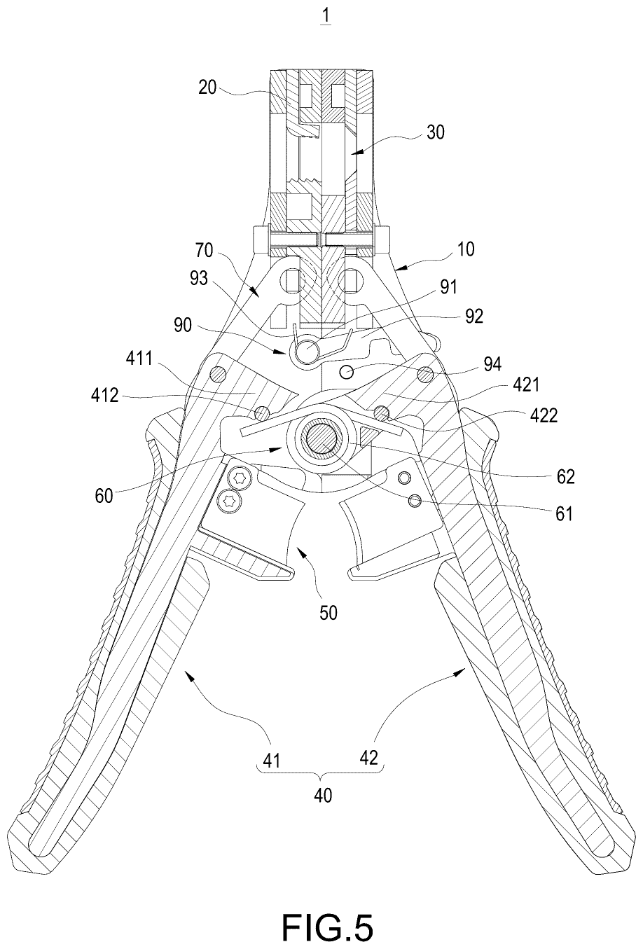

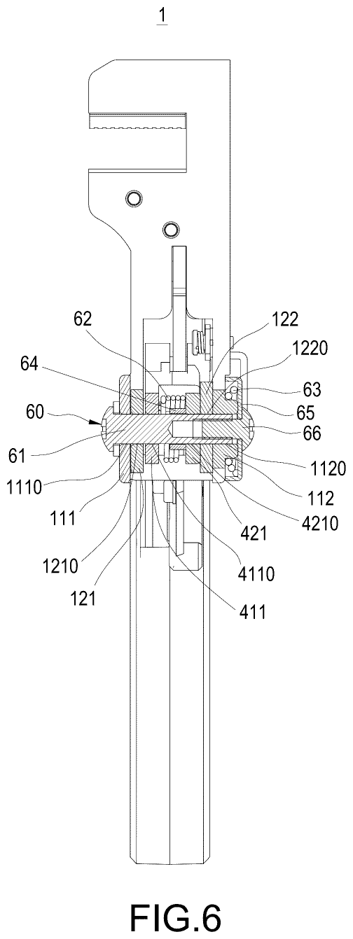

Please refer to FIG. 5 and FIG. 6, which depict cross-sectional views of the ratchet crimping plier structure according to this disclosure. As shown in FIG. 5, the first plier handle set 41 further includes a first blocking post 412 located on the first arm 411. The second plier handle set 42 further includes a second blocking post 422 located on the second arm 421. Additionally, one end of the first torsion spring 62 abuts against the first blocking post 412, and the other end abuts against the second blocking post 422. Accordingly, when the pair of plier handle sets 40 is pressed and drives the first arm 411 and the second arm 421, the two ends of the first torsion spring 62 are respectively pressed by the first blocking post 412 and the second arm 421 to generate elastic restoring force. It should be noted that when the pair of plier handle sets 40 is not pressed, the buckle arm 92 of the elastic arm set 90 is not engaged with the fixed shaft 91. Thus, the third torsion spring 93 is in a free state, and both the clamp-cutting set 30 and the edge-cutting set 50 are in a non-operational state.

As shown in FIG. 6, the pivot set 60 is disposed on the main body 10 and includes a central shaft 61, a first torsion spring 62, a second torsion spring 63, a sleeve 64, a rear cover 65, and a fastener 66. The central shaft 61 sequentially passes through the first front plate 111 (first front hole 1110), the second front plate 121 (second front hole 1210), the first arm 411 (first perforation 410), the first torsion spring 62, the second arm 421 (second perforation 420), the second rear plate 122 (second rear hole 1220), the first rear plate 112 (first rear hole 1120), the second torsion spring 63, and the rear cover 65.

It is worth noticing that the central shaft 61 does not rotate, and the first torsion spring 62 and the second torsion spring 63 are adapted to sheathe thereon. The sleeve 64 is positioned between the central shaft 61 and the first torsion spring 62 to prevent friction on the central shaft 61 when the first torsion spring 62 rotates. Additionally, the fastener 66 is screwed to the central shaft 61 to lock the rear cover 65 and cover the second torsion spring 63.

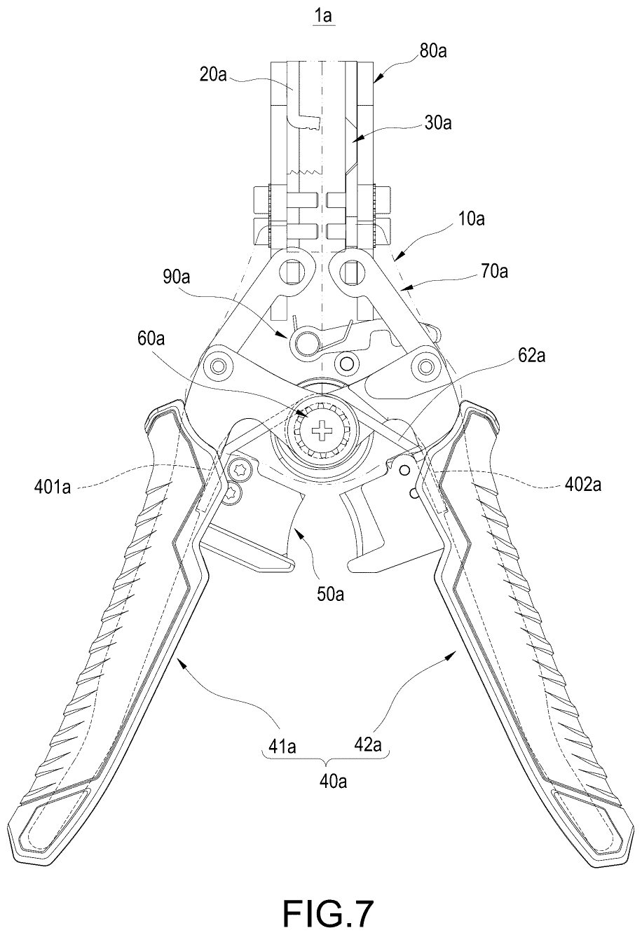

Please further refer to FIG. 7, which depicts another embodiment of this disclosure. This embodiment is substantially the same as the previous embodiment. The ratchet crimping plier structure 1a includes a main body 10a, a clamping piece 20, a clamp-cutting set 30, a pair of plier handle sets 40, an edge-cutting set 50, a pivot set 60, a linkage set 70a, a panel set 80a, and an elastic arm set 90. The difference between this embodiment and the previous embodiment lies in the length of the two fixed ends of the first torsion spring 62a of the pivot set 60a.

In this embodiment, the two fixed ends of the first torsion spring 62a extend to the handles of the pair of plier handle sets 40a. Specifically, in the pair of plier handle sets 40a, a first groove 401a is defined on the first plier handle set 41a, and a second groove 402a is defined on the second plier handle set 41a. Both ends of the first torsion spring 62a extend and are engaged in the first groove 401a and the second groove 402a, respectively. As a result, different elastic restoring forces are generated when the pair of plier handle sets 40a is pressed.

While this disclosure has been described by means of specific embodiments, numerous modifications and variations may be made thereto by those skilled in the art without departing from the scope and spirit of this disclosure set forth in the claims.

What is claimed is:

1. A ratchet crimping plier structure, comprising:
a main body, comprising a first base and a second base disposed correspondingly;
a clamping piece, disposed on one side of the first base;
a clamp-cutting set, disposed on one side of the second base;
a pair of plier handle sets, comprising a first plier handle set pivotally connected to the first base and a second plier handle set pivotally connected to the second base;
an edge-cutting set, disposed on the pair of plier handle sets correspondingly; and
a pivot set, disposed in the main body, comprising a central shaft, and a first torsion spring and a second torsion spring located on two sides of the central shaft opposite to each other, wherein one end of the first torsion spring abuts against the first plier handle set, and another end of the first torsion spring abuts against the second plier handle set; one end of the second torsion spring is fixed on the central shaft, and another end of the second torsion spring is fixed on the second base;
wherein the central shaft passes through the main body, the pair of plier handle sets, the first torsion spring, and the second torsion spring to be fixed on the main body; the pair of plier handle sets opens and closes relative to each other through the first torsion spring to perform a horizontal cut by the edge-cutting set; and the second base performs a vertical cut by the clamp-cutting set through the second torsion spring.

2. The ratchet crimping plier structure according to claim 1, wherein the first base comprises a first jaw section, and a serrated pattern is disposed on a surface of the first jaw section; the second base comprises a second jaw section disposed corresponding to the first jaw section.

3. The ratchet crimping plier structure according to claim 2, wherein the first base comprises a first front plate and a first rear plate arranged oppositely, a first front hole is defined on the first front plate, and a first rear hole is defined on the first rear plate, and the first jaw section straddles between the first front plate and the first rear plate; the second base comprises a second front plate and a second rear plate arranged oppositely, a second front hole is defined on the second front plate, and a second rear hole is defined on the second rear plate; and the central shaft sequentially passes through the first front hole, the second front hole, the second rear hole, and the first rear hole.

4. The ratchet crimping plier structure according to claim 2, further comprising a linkage set, wherein the linkage set comprises a first rod and a second rod; two ends of the first rod are pivotally and respectively connected to the first plier handle set and the clamping piece, and two ends of the second rod are pivotally and respectively connected to the second plier handle set and the clamp-cutting set.

5. The ratchet crimping plier structure according to claim 4, wherein the clamp-cutting set comprises a fixed blade and a movable blade, and the fixed blade and the movable blade are arranged on two sides of the second jaw section opposite to each other, and one end of the second rod is connected to the movable blade.

6. The ratchet crimping plier structure according to claim 4, further comprising a panel set, wherein the panel set comprises a first panel and a second panel, and the first panel is fixed to the first base and covers the clamping piece, and the clamping piece is driven by the first rod to move between the first panel and the first base; the second panel is fixed to the second base and covers the clamp-cutting set, and the movable blade is driven by the second rod to move between the second panel and the second base.

7. The ratchet crimping plier structure according to claim 1, wherein the pivot set further comprises a sleeve located between the central shaft and the first torsion spring.

8. The ratchet crimping plier structure according to claim 3, wherein the pivot set further comprises a rear cover and a fastener, and the rear cover covers the second torsion spring, and the fastener passes through the rear cover and is combined with the central shaft.

9. The ratchet crimping plier structure according to claim 8, wherein the first plier handle set comprises a first arm, and a first perforation is defined on the first arm; the second plier handle set comprises a second arm, and a second perforation is defined on the second arm; the central shaft passes through the first front hole, the second front hole, the first perforation, the first torsion spring, the second perforation, the second rear hole, the first rear hole, and the rear cover.

10. The ratchet crimping plier structure according to claim 1, further comprising an elastic arm set disposed on the main body, wherein the elastic arm set comprises a fixed shaft, a buckle arm, a third torsion spring, and a buckle column; the fixed shaft is fixed on the first base and passes through the buckle arm and the third torsion spring; the buckle arm extends to the second base, and a locking groove is defined on the buckle arm; one end of the third torsion spring is positioned on the first base, and another end of the third torsion spring elastically contacts the buckle arm, and the buckle column is located on the second base, wherein the locking groove is engaged with the buckle column when the pair of plier handle sets is pressed, and the locking groove returns to an original position by the third torsion spring.
